(19) United States
(12) Patent Application Publication
(10) Pub. No.: US 2010/0326833 A1
(43) Pub. Date: Dec. 30, 2010

(54) APPARATUS AND SYSTEM FOR DEIONIZATION

(76) Inventors: Rami Messalem, Omer (IL); Ora Kedem, Beer Sheva (IL); Charles Linder, Rehovot (IL)

Correspondence Address: WINSTON & STRAWN LLP;PATENT DEPARTMENT, 1700 K STREET, N.W., WASHINGTON, DC, 20006, US

(21) Appl. No.: 12/808,566

(22) PCT Filed: Dec. 17, 2008
(86) PCT No.: PCT/IB2008/055380

§ 371 Date: Sep. 3, 2010

Related U.S. Application Data
(60) Provisional application No. 61/006,047, filed on Dec. 17, 2007.

(51) Int. Cl. B01D 61/50; B01D 61/42

(52) U.S. Cl. 204/632; 204/627

(57) ABSTRACT

There is provided herein a membrane package comprising a plurality of membranes, wherein said membrane package is adapted to facilitate a feed stream flow having a process stream flow wherein said hydrodynamic resistance of said feed stream flow is substantially the same as said hydrodynamic resistance of said process stream flow.

### FIELD

The invention relates to devices, apparatus and systems for fluid deionization, for example, as is used in water desalination.

### BACKGROUND

Electrodialysis (ED) is a relatively mature desalting technology invented before reverse osmosis (RO). In pressure driven systems such as RO and nanofiltration (NF) feed water is pressurized to exceed an osmotic pressure, and water passes through a semi-permeable membrane while dissolved solids are rejected and remain on a feed water side, eventually concentrating into a brine solution. The systems driven by electric potential (ED) apply voltage to opposite ends of a membrane package, one positive terminal and one negative. So, while the pressure-driven system selectively passes water and retains dissolved salts, an electrically driven system extracts dissolved salts and retains the water. Either way, the water and salts are separated, producing low salinity water. The potential advantage of ED over RO is its applicability in very high salt concentrations as well as in brackish water, since no high pressures are required for the process; at one time, table salt in Japan was produced for years by ED from seawater. Hence ED can solve a crucial, currently expensive, unsolved problem of brine disposal in the desalting of brackish water. Since ED, unlike reverse osmosis, removes salts from the feed water, and not water from the solutes, it is also particularly advantageous for the treatment of brackish water containing relatively low amounts of salt.

ED is used in different applications where the composition of two separate streams flowing through the stack depends on the nature of the process. For example, the feed stream may be a mixed solution containing a valuable product and salts which are to be removed by the ED, and the second stream, to be termed here generally a process stream, will be a solution of the removed salt. In another case, reverse electrodialysis (RED) extracts energy from a concentration difference by permeation of salt from a concentrated feed solution, such as sea water, into surface water or any dilute water source in an ED stack. In this case, the feed stream is for example, seawater and the process stream is, for example, river water.

Stacks comprising ion exchange membranes of one kind may be used for ion exchange driven by an electric current, for example all cation exchange stacks, for acidification. In this case the feed is the solution which should be acidified, and the process stream is an acid solution.

A process for ion exchange through membranes, so called Donnan dialysis or diffusion dialysis, can be carried out in stacks comprising only cation exchange membranes or only anion exchange membranes.

Usually, ED cannot be carried out in very dilute solutions, because the electric resistance becomes prohibitively high, due to bulk resistance and even more due to strong concentration polarization. This can be overcome by filling diluate compartments with ion exchange resin, usually mixed bed. This process, used for preparation of ultra pure water, is a version of electrodialysis, so-called electro-deionization (EDI) or continuous electro-deionization (CEDI). For some deionization stacks a cation exchange membrane and an anion exchange membrane are sealed to a spacer, and the resulting diluate cell is filled with ion exchange resin. More about such stacks for deionization may be found in Giuffrida et al., Electro-deionization apparatus and method, U.S. Pat. No. 4,925,541, 1990; Liang et al. Modules for electro-deionization apparatus, U.S. Pat. No. 5,292,422, which are hereby incorporated by reference in their entirety.

In currently available commercial ED equipment, the cost of the membrane package is a large part of the total initial investment. The filter press concept, the expensive membranes and the gaskets all contribute to the high cost of the stack. A less expensive stack would make the process more competitive.

It was previously attempted to decrease the number of separate items in the ED stack by gluing or sealing of elements to each other. For example, it was reported that a sealed cell ED stack was created in which cation exchange and anion exchange membrane were sealed together to form bags with one outlet. Another stack was reported in which each membrane is glued to a separate frame. None of these leads to substantial simplification of the stack or to better operation. More about these stacks can be found in:
Kedem, O., Cohen, J., Warshawsky, A. and Kahana, N. EDS—Sealed cell electrodialysis. Desalination 46, 291-299 (1983);
Kedem, O., Bar-On, Z. and Warshawsky, A. Electroosmotic pumping in a sealed cell ED stack. AICHE Symp. Series 248, vol. 82:19 (1986);
Schmoldt et al., Electrodialysis cell assembly, U.S. Pat. No. 4,350,581;
Messalem R., Kedem O. and Kedem A. Module for an Electrodialysis stack, Israeli patent IL 120635; and
Kedem O. and Kedem A. Modular Electrodialysis device, U.S. Pat. No. 4,569,747;
   all of which are hereby incorporated by reference in their entirety.

Preparation procedures of ion exchange membranes for ED and Donnan dialysis are extensively documented in the above-mentioned references and technical literature. See, for example, Chapter 3 in H. Strathmann “Ion Exchange Membrane Separation Processes” Membrane Science and Technology Series 9, Elsevier 2004 and references therein, incorporated herein by reference in its entirety.

Widely applied chemically stable cation exchange membranes based on ionomers are prepared from perflorinated monomers carrying sulfonic groups. (Yeager, 1982) Membranes based on ionomers obtained by derivatization of aromatic polymers, or on mixtures of ionomers and uncharged aromatic polymers are described, for example, by Zschocke et al, by Balzer et al. and by Eyal et al. More details about these membranes can be found in Yeager, ASC Symposium Series 180, American Chemical Society, Washington D.C., Zschocke and Quellmalz, J. of Memb. Sci. 22 (1985), p. 325, P. Wilhelm J. Balster et al. in J. Phys. Chem., 2007 and in A. Eyal et al., J. of Memb. Sci., 38 (1988) p. 101, all of which are herein incorporated by reference in their entirety.

Commercial ion exchange membranes have to be introduced into the stack in wet state and be kept wet thereafter. Data on the swelling of ion exchange membranes are collected in the book by Strathmann mentioned above, p. 119.

### SUMMARY

There is provided according to some embodiments of the invention, a membrane package comprising a plurality of cell pairs, for example, 10-100 cell pairs. The membrane package is adapted to allow essentially free flow of both feed and process streams, such as, but not limited to, diluate and concentrate solution in a desalination process, acid and basic solution in a neutralization process, a concentrated feed stream and a more dilute water source in ED for energy conversion, or any other combinations of streams required for a desired process. The membrane package is adapted to allow essentially free flow through both feed and process compartments where there is no mixing by leakage between the two solutions (feed and process streams).

There is further provided, according to some embodiments, a membrane package comprising a plurality of sleeves, bound to each other along two parallel edges, for example by a potting procedure, at a distance defined by a first spacer, wherein each sleeve comprise two membranes separated from each other by a second spacer, and wherein the two membranes are sealed along two parallel edges, perpendicular to the two edges of the bound sleeves. The membrane package further allows entrance of fluid into the sleeves by suitable opening of the potted body, and thus two flow pathways perpendicular to each other may be obtained.

According to some embodiments, a first membrane may be connected to a first spacer along two parallel edges by means of a connecting element, for example a solid strip of a suitable material. A second membrane may be connected to the first spacer along the same edges by means of the same, or optionally a different connecting element. A second spacer may be connected to the second membrane along two parallel edges perpendicular to the seals between the first spacer and the first and second membranes. A third membrane may be connected to the second spacer along the edge sealed to the second membrane. A membrane package is constructed by this method, with spacers sealed along two edges in alternating perpendicular directions, and thus creating perpendicular flow paths for two streams.

According to some embodiments, the membrane package may be included in a module (membrane module) which further includes a rigid frame. The frame may be shaped so that the membrane package can be inserted and connected in predetermined areas, for example at corners, to the frame. Separate open spaces are created for entry and exit of feed and process streams, allowing flow of these streams through the membrane package in perpendicular directions, without mixing or leakage between the streams.

According to some embodiments, there is provided an ED stack comprising two or more modules having a gasket between them. The modular stack further comprises electrode cells on both ends, which may serve also as end plates.

In some embodiments, suitable gasket material may be glued onto one side of the rigid frame.

In some other embodiments, a framed cell may be glued onto one side of the module, comprising an anion exchange membrane and a cation exchange membrane cell glued on a thin frame.

An ED stack can be formed by one or more modules put alongside each other and held together by conventional electrode cells, serving as end plates, with suitable mechanical connection between them.

According to some embodiments of the invention, feed and process stream may enter and exit through ports in the electrode plates. In the assembled stack the two streams are totally separated from each other, and their roles can be exchanged periodically in an EDR system.

Sealed stacks for electro-deionization (EDI) may be constructed, according to embodiments of this invention, where the distance between the membranes is adapted to enable filling with ion exchange resin. The sleeves may be filled with ion exchange resin held in place, for example, by suitable nets attached to the edges of the membrane package. Sleeves may be prepared without spacers, leaving room for the resin. It may also be possible to prepare sleeves containing a spacer and to fill the spaces between sleeves with ion exchange resin, retaining the ion exchange resin with suitable nets, or the like.

According to some embodiments of the invention, shape-stable cation exchange and anion exchange membranes may be provided for preparation of the sleeves. The shape-stable membranes used maintain their dimensions in both dry and wet conditions to within 10% and preferably 5% and most preferred within or less than 2%. Change of dimensions is minimized by limited swelling of the polymer material by cross-linking and/or mixing with uncharged polymer(s).

Heterogeneous membranes used in some systems for EDI may be sealed in wet state.

An aspect of some embodiments of the invention relates to providing a device and an apparatus for diluting and/or concentrating a solution in a desalination process; forming an acid and/or a basic solution in a neutralization process; diffusing a concentrated solution and a more dilute water source in an energy conversion process; selectively moving ions in a solution, or optionally de-ionizing the solution, as may be required by a desired process; and/or any combination thereof. The apparatus may be adapted to use processes which include ED, reverse ED (EDR), Donnan Dialysis, Electro-deionization (EDI), Continuous Electro-deionization (CEDI), and the like. The apparatus, a system comprising the apparatus, and a method comprising the use of the apparatus, are disclosed herein.

Embodiments of the present invention may be advantageously applied to EDI. Large units can be constructed and readily filled with ion exchange resin. For example, all (or part of the) compartments may be at least partially filled with resin.

Membranes are sealed to each other in the membrane package by strips (for example, of thickness of 2-4 mm), with the strips vertically alternating. Very open spacers may be inserted. The spacers may be chosen to allow introduction of resin with pressurized solution but to still stabilize the resin bed. Alternatively, a membrane package without spacers may be constructed.

In some embodiment, a suitable net may be fastened to one side of the membrane package, a measured amount of the mixed resin poured into the other end of the package with solution, and the second edge closed with a net. The package may then be turned 90°, and the procedure may be repeated.

According to an aspect of some embodiments of the invention, the apparatus comprises a module (device) adapted to allow a substantially free flow of a feed stream and a process stream through the module, the module comprising a relatively low hydrodynamic resistance to the flow of the two streams. In some embodiments of the invention, the hydrodynamic resistance of the module is determined essentially by the hydrodynamic resistance of the spacers (and not the hydrodynamic resistance of entrance/exit ports comprised in the module). The module comprises a plurality of cell pairs, for example 1-10 cell pairs, 10-20 cell pairs, 20-40 cell pairs, 40-80 cell pairs, 80-160 cells pairs, 160-320 cell pairs, and optionally more than 320 cell pairs. Each cell pair may comprise a first ion exchange membrane attached (for example, by thermal sealing, gluing, and/or cross linking polymers contained in the spacers and the membranes) on one side to a first spacer along two opposing, parallel edges on a first side of the spacer; a second ion exchange membrane attached on one side to the first spacer along the opposing, parallel edges on a second side of the spacer; and a second spacer attached on a first side to a second side of the second membrane along two opposing, parallel edges perpendicular to sealed edges in the first spacer. A third ion exchange membrane associated with a second cell pair may be attached to the second spacer along the opposing parallel edges on a second side of the spacer. A membrane package may be constructed in this way, with spacers attached along two edges in alternating perpendicular directions to that of the ion exchange membranes, creating perpendicular flow paths for the two streams. For example, the feed stream may flow into the first spacer along a whole length of an unsealed edge, essentially flowing across a whole cross-section of the spacer, and may flow out along the whole length of the opposite unsealed edge. The process stream may flow into the second spacer along a whole length of an unsealed edge, essentially flowing across a whole cross-section of the spacer, and may flow out along the whole length of the opposite unsealed edge, essentially perpendicularly to the flow of the feed stream.

In some embodiments of the invention, the cell pair may be formed by attaching the first membrane and the second membrane along opposing, parallel edges forming a sleeve, the spacer inserted inside the sleeve and attached to the membranes. The second spacer is attached on a first side to a second side of the second membrane along two opposing, parallel edges perpendicular to the attached edges of the sleeve. The membrane package may be constructed by attaching a second sleeve associated with a second cell pair to the second spacer along the two opposing, parallel edges on a second side of the spacer, creating perpendicular flow paths for the two streams.

In the prior art, apparatus adapted to selectively move ions in a solution, or optionally de-ionize the solution, frequently comprise spacers with narrow entry and exit ports for the feed stream and the process stream. The use of narrow ports frequently reduces a probability of leakage in the spacer, although a problem frequently arises as the ports, due to their narrow size, are susceptible to clogging. Furthermore, the narrow size of the ports contribute to a relatively large hydrodynamic resistance, the high resistance frequently requiring an increase in pumping energy to maintain a relatively high flow rate in the streams. This, in turn, generally leads to an apparatus with relatively high energy consumption.

According to an aspect of some embodiments of the invention, the apparatus comprises a module positioned between two electrodes. Optionally, the module may be configured into a vertical stack of modules by placing one module on top of another module. Optionally, the module may be configured into a horizontal stack of modules by placing one module next to another module. Additionally or alternatively, a gasket may be placed between each module in the stack. Optionally, the stack may be positioned between the two electrodes. Optionally, the electrodes may be comprised in end plates. The electrodes, which may comprise an anode (positively charged terminal) and a cathode (negatively charged terminal), are adapted to create a direct current flow through the module(s) when the feed stream and the process stream flow through the module(s) (and the electrodes are connected to a DC voltage source). Optionally, the electrodes are adapted to change polarity responsive to a reversing of polarity in the voltage source, the direction of direct current flow in the module(s) according to the polarity of the electrodes.

In an embodiment of the invention, the module may comprise a frame adapted to support the membrane package. The frame may be further adapted to allow free flow of the feed stream and the process stream inside the module, while substantially preventing the streams from mixing with one another. For example, the frame may be shaped so that a membrane package can be inserted and connected at predetermined areas in the frame, forming compartments adapted to allow entry and exit of the feed and process streams in the module, and further adapted to allow flow of the two streams through the membrane package without mixing or leakage between the streams. The frame may be additionally adapted to allow flow of the feed stream and the process stream from one module to another, without mixing of the streams when the modules are stacked. The frame may be of a plastic material, a composite material and/or any other material or combination of materials adapted to substantially resist contact with the feed stream and the process stream. Optionally, a gasket material may be affixed to the frame.

As an alternative to the gaskets described herein, there is provided a plate containing a cell pair which may form one side of each module in a multi-module stack and thus may function as an alternative to the gasket between modules. Both ends of each membrane package end with a spacer, and connecting strips oriented in a same direction, without a membrane. Optionally, the connecting strips at one end are oriented in a different direction from those at the other end, for example, perpendicular to one another. When the package is inserted into the frame, both strips are level with the surface of the frame. If the ED stack comprises only one module the frame and strips will be pushed against the electrode compartments, which are coated with a thin elastic layer.

For multi-module stacks, a thin plate is added onto one side of each module. This plate matches the frame, with openings for both feed and process streams. The plate includes a cell consisting of two membranes sealed to the edges of a rectangular opening in the plate, with a spacer between them. Flow through the cell i is enabled by entrance/exit ports along the edges of the opening perpendicular to the orientation of the connecting strip The thickness of the plate width of the cell and size and number of entrance/exit ports are adjusted so that the hydrodynamic resistance of the cell is equal to or slightly larger than that of the cells in the membrane package. The plate is adhered to the frame on one side of the membrane package, generally by attaching to the strips on the spacer The other surface of the thin plate is covered with a relatively thin elastic layer.

In some embodiments of the invention, the module may comprise cell pairs wherein the ion exchange membranes in each cell pair comprise a cation exchange membrane and an anion exchange membrane, for example, for use with apparatus for ED. Optionally, the ion exchanges membranes comprised in each cell pair comprise only cation exchange membranes, for example, for use with apparatus for acidification processes or Donnan dialysis. Optionally, the ion exchanges membranes comprised in each cell pair include only anion exchange membranes, for example, for use with apparatus for Donnan dialysis. The ion exchange membranes may comprise shape-stable cation exchange and/or anion exchange membranes, the membranes adapted to maintain their linear dimensions in both dry and wet conditions to within 10% or less. Optionally, the dimensions are maintained to within a range of 5%-10% in both dry and wet conditions. Optionally, the dimensions are maintained to within a range of 2%-5% in both dry and wet conditions. Optionally, the dimensions are maintained to 2% or less in both dry and wet conditions. Change of dimensions may be minimized by limited swelling of the polymer material by cross linking and/or or mixing with uncharged polymer(s).

In some embodiments of the invention, the modules may be adapted for use with apparatus for EDI and/or CEDI. An ion exchange resin may be used between the ion exchange membranes in place of the spacer. The ion exchange resin may be held in place, for example, by suitable nets attached to the edges of the membrane package. Optionally, the ion exchange resin is used to fill a space between the spacer and the ion exchange membranes, the ion exchange resin retained with suitable nets, or the like.

According to some aspects of the invention, an ED system may be provided. The ED system may comprise an ED apparatus, a pretreatment system, a control system, and an optional cleaning system. The pretreatment system may be adapted to precondition the feed stream, and may include filtering large solids, anti-bacterial treatment, anti-fouling treatment, and/or anti-scaling treatment. The cleaning system may be adapted to clean the stacks, the electrodes, and other components of the ED apparatus. Optionally, the cleaning system may be adapted to clean the pretreatment system. The control system may be adapted to control operation of the pretreatment system and/or the EDR apparatus.

In some embodiments of the invention, the system may comprise an EDR apparatus. Optionally, the system may comprise an acidification apparatus, or a neutralization apparatus. Optionally, the system may comprise a Donnan dialysis apparatus. Optionally, the system may comprise an EDI or a CEDI apparatus. Optionally, the system may comprise any apparatus adapted to selectively move ions in a solution, or optionally de-ionize the solution. Optionally, the system may comprise any one or any combination of the above-mentioned apparatus. Optionally, the system may comprise a plurality of the above-mentioned apparatus; the apparatus may be serially connected together. Optionally, the plurality of apparatus may be connected in a parallel configuration. Optionally, the plurality of apparatus may be connected in any combination of parallel—serial configurations.

In some embodiments of the invention, the ED systems and apparatuses described herein may be used for any of the applications mentioned herein. The ED systems and apparatuses described herein may also be used for desalting of biologically treated municipal waste.

To make municipal waste water treated by ultrafiltration (UF), following biotreatment suitable for unlimited irrigation, the salt content must not exceed a certain threshold. This also applies when membrane bio-reactors, which include UF, are used, whether immersed or as a side arm. Salt can be removed by ED with current reversal (EDR). The stacks, as disclosed herein according to some embodiments, may save energy due to low hydrodynamic resistance, and the symmetric structure thereof, which allows current reversal. With the dense ion exchange membranes available for the stack, the only brine produced will be a concentrated salt solution with minimal organic content, facilitating extraction of valuable components, such as Potassium.

For desalting of waste water and for some industrial applications, low permeability to organic anions is required, as well as low permeability to scale forming phosphate and sulfate. At the same time, concentration polarization has to be minimized. For brine treatment, high permselectivity in concentrated salt solutions is essential; low water permeability enables a high concentration factor. Problems associated with concentration polarization are essentially non-existent.

According to some embodiments of the invention, there is provided a system which may include one or more of the three types of units:

1. A membrane package including membranes and spacers suitably connected. The connecting element, such as a connecting strip, disposed essentially along the edges of the spacers may be part of the spacer or separate items.

2. A module (membrane module) which includes a membrane package, a frame into which the membrane package is attached (for example, glued) to the frame. The package includes two separate spaces, entrance and exit spaces for the two streams. To one side of the module, an elastic gasket or a framed cell may be added.

3. An electrodialysis (ED) stack which includes one or more modules, electrodes for the passage of current, entrance and exit ports for solution flow, and connecting means to hold the elements together. The ED stack may be used for reverse electrodialysis (RED), wherein an electric current is created in the ED stack by a diffusion of salt from a high concentration into a low concentration, or for Electrodialysis Reversal (EDR)

There is provided, in accordance with an embodiment of the invention, a cell pair comprising a first membrane, a second membrane, a first spacer between the first membrane and the second membrane, a second spacer adjacent to the second membrane; wherein the first membrane is connected to the first spacer along two parallel edges of the first spacer, and wherein the second membrane is connected to the first spacer along the two parallel edges of the first spacer, and wherein the second spacer is connected to the second membrane along two parallel edges of the second spacer, and wherein the parallel edges of the second spacer are perpendicular to the two parallel edges of the first spacer. Optionally, the cell pair is adapted to allow feed stream flow on one side of the second membrane and a process stream flow on a second side of the second membrane, and wherein the feed stream flow is essentially perpendicular to the process stream flow. Optionally, the cell pair is adapted to allow feed stream flow through the first spacer and a process stream flow through the second spacer, wherein the feed stream flow is essentially perpendicular to the process stream flow.

There is provided, in accordance with an embodiment of the invention, a membrane package comprising a plurality of cell pairs wherein at least a portion of the cell pairs each comprise a first membrane, a second membrane, a first spacer between the first membrane and the second membrane, a second spacer adjacent to the second membrane; wherein the first membrane is connected to the first spacer along two parallel edges of the first spacer, and wherein the second membrane is connected to the first spacer along the two parallel edges of the first spacer, and wherein the second spacer is connected to the second membrane along two parallel edges of the second spacer, and wherein the parallel edges of the second spacer are perpendicular to the two parallel edges of the first spacer. Optionally, the membrane package is adapted to allow feed stream flow on one side of the second membrane and a process stream flow on a second side of the second membrane and wherein the feed stream flow is essentially perpendicular to the process stream flow. Optionally, the membrane package is adapted to allow feed stream flow through the first spacer and a process stream flow through the second spacer, wherein the feed stream flow is essentially perpendicular to the process stream flow. Optionally, a hydrodynamic resistance of the feed stream flow and the process stream flow is essentially determined by a hydrodynamic resistance of the spacers.

In some embodiments of the invention, the first membrane, the second membrane, or both, are ion exchange membranes. Optionally, the first membrane is an anion exchange membrane. Optionally, the second membrane is a cation exchange membrane. Additionally or alternatively, the first membrane and the second membrane are cation exchange membranes.

In some embodiments of the invention, the second spacer is adapted to be connected to a third membrane along the two parallel edges of the second spacer, such that the second spacer is disposed between the second membrane and the third membrane.

In some embodiments of the invention, the cell pair is adapted to be used in electrodialysis ED, electrodialysis reversal (EDR), Donnan Dialysis, Electro-deionization (EDI), Continuous Electro-deionization (CEDI) and reversed electrodialysis (RED).

There is provided, in accordance with an embodiment of the invention, a membrane package comprising a plurality of membranes, wherein the membrane package is adapted to facilitate a free flow of a feed stream and a free flow of a process stream. Optionally, a hydrodynamic resistance of the feed stream flow and the process stream flow is essentially determined by a hydrodynamic resistance of the spacers.

There is provided, in accordance with an embodiment of the invention, a membrane module comprising a membrane package comprising a plurality of membranes, wherein the membrane package is adapted to facilitate a free flow of a feed stream and a free flow of a process stream; and a frame adapted to support the membrane package. Optionally, the membrane package comprises a plurality of cell pairs wherein at least a portion of the cell pairs each comprise a first membrane, a second membrane, a first spacer between the first membrane and the second membrane, and a second spacer adjacent to the second membrane; wherein the first membrane is connected to the first spacer along two parallel edges of the first spacer, and wherein the second membrane is connected to the first spacer along the two parallel edges of the first spacer, and wherein the second spacer is connected to the second membrane along two parallel edges of the second spacer, and wherein the parallel edges of the second spacer are perpendicular to the two parallel edges of the first spacer. Additionally or alternatively, the frame is further adapted to allow free flow of the feed stream and the process stream inside the module, while substantially preventing the streams from mixing with one another. Optionally, a hydrodynamic resistance of the feed stream flow and the process stream flow is essentially determined by a hydrodynamic resistance of the spacers.

### BRIEF DESCRIPTION OF FIGURES

Examples illustrative of embodiments of the invention are described below with reference to figures attached hereto. In the figures, identical structures, elements or parts that appear in more than one figure are generally labeled with a same numeral in all the figures in which they appear. Dimensions of components and features shown in the figures are generally chosen for convenience and clarity of presentation and are not necessarily shown to scale. The figures are listed below.

FIG. 1A schematically illustrates an exemplary ED device, as known in the art;

FIG. 1B schematically illustrates an exploded isometric view of part of an ED device and of a cell pair included in a membrane package, shown in FIG. 1A, as known in the art;

FIG. 2 schematically illustrates an exploded isometric view of a plurality of cell pairs comprised in a membrane package comprised in an apparatus, in accordance with an embodiment of the invention;

FIG. 3 schematically illustrates an exploded isometric view of a plurality of exemplary cell pairs comprised in a membrane package comprised in an apparatus, the apparatus adapted for diluting and/or concentrating a solution in a desalination process, in accordance with an embodiment of the invention;

FIG. 4A schematically illustrates an isometric view of an exemplary module comprised in the apparatus of FIG. 2, in accordance with an embodiment of the invention;

FIG. 4B schematically illustrates a flow chart of an exemplary mode of operation of the module shown in FIG. 4A, in accordance with an embodiment of the invention;

FIG. 4C schematically illustrates an isometric view of an exemplary module comprised in the apparatus of FIG. 3, in accordance with another embodiment of the invention;

FIG. 5 schematically illustrates an exploded isometric view of a part of an apparatus, configured with a modular stack comprising a plurality of modules shown in FIG. 4A, in accordance with an embodiment of the invention;

FIGS. 5A and 5B schematically illustrate an exemplary plate and elastic layer for use in a multi-module stack, in accordance with an embodiment of the invention; and

FIG. 6 schematically illustrates a system comprising an apparatus adapted to perform ED, in accordance with an embodiment of the invention.

### DETAILED DESCRIPTION

### Glossary

Unless otherwise noted, or as may be evident from the context of their usage, any terms, abbreviations, acronyms or scientific symbols and notations used herein are to be given their ordinary meaning in the technical discipline to which the disclosure most nearly pertains. The following terms, abbreviations and acronyms may be used throughout the descriptions presented herein and should generally be given the following meaning unless contradicted or elaborated upon by other descriptions set forth herein. Some of the terms set forth below may be registered trademarks (®).

When glossary terms (such as abbreviations) are used in the description, no distinction should be made between the use of capital (uppercase) and lowercase letters. For example “ABC”, “abc” and “Abc”, or any other combination of upper and lower case letters with these 3 letters in the same order, should be considered to have the same meaning as one another, unless indicated or explicitly stated to be otherwise. The same commonality generally applies to glossary terms (such as abbreviations) which include subscripts, which may appear with or without subscripts, such as “X_{yz}” and “Xyz”. Additionally, plurals of glossary terms may or may not include an apostrophe before the final “s”—for example, ABCs or ABC's.
Cell pair may refer to, according to some embodiments, two adjacent ion-exchange membranes, a spacer between the two membranes and a spacer adjacent to one membrane, and a spacer connecting element. The spacer connecting element, such as, for example, a solid strip of a suitable material, is used for connecting the membrane to the spacer, and may be part of the spacer, or a separate component. For characterization of a performance of a process, the term cell pair may also refer to, in addition (or alternative) to the membrane and spacers, solutions in one feed compartment and one process compartment.
Charge density may refer to, according to some embodiments, an amount of fixed charges per volume in a membrane, the volume including polymer and water.
Compartment may refer to, according to some embodiments, a volume defined by a spacer between two membranes.
Concentrate may refer to, according to some embodiments, a process stream in desalination, or other ED processes concentrating a salute.
Cross linking or cross-link may refer to, according to some embodiments, the formation of covalent bonds linking one polymer and/or oligomer chain to another. Cross linking may also be brought about by interactions other than covalent bonds such as electrostatic or hydrophobic interactions. Unless otherwise stated, cross linking refers to covalent bonds.
Diluate, according to some embodiments, is an alternative term for feed stream in ED desalination.
Electrode cells may refer to, according to some embodiments, housing (for example plastic) sealed by membranes, containing the electrodes which supply the electric current passing through the membrane packages and solutions. The electrode cells may serve also as end plates in an ED stack.
Electro-deionization (EDI) may refer to, according to some embodiments, a process for desalting of dilute saline solutions using membrane packages in which the feed (diluate) compartment, or both feed and process compartments, is at least partially filled with ion exchange resin.
Electrodialysis may refer to, according to some embodiments, a process comprising transferring ions through semi-permeable membranes, driven by an electric potential.
Electrodialysis Reversal (EDR) may refer to, according to some embodiments, an electrodialysis process in which the direction of the electric current is reversed at predetermined intervals.
Electrodialysis (ED) stack may refer to, according to some embodiments, a stack containing membranes; spacers and gaskets (usually connected) allowing the flow of at least two solutions; electrodes enabling electric flow through membranes and solutions and serving as end plates; and means to keep these together. The end plates may carry the entrance and exit ports of the solutions.
End plates may refer to, according to some embodiments, plates (for example, flat plates) at one or both ends of the ED stack, held together (for example, mechanically) and thus holding together one or more membrane packages and/or modules.
Feed stream may refer to, according to some embodiments, a solution to be processed by electrodialysis, flowing through at least every second compartment, referred to as feed compartments.
Framed cell may refer to, according to some embodiments, a plate at one end of a module with opening(s) for the feed and process streams with a cell consisting of anion exchange and cation exchange membranes sealed into it.
Free flow may refer to, according to some embodiments, an entrance and exit of the fluid stream into compartments defined by spacers in sleeves and/or into compartments defined by spacers between exchange membranes, essentially through the entire cross-section of the spacer.
Gasket may refer to, according to some embodiments, a frame generally made of elastic material providing seals between the membranes and carrying ports for entrance and exit of feed and process streams. Spacer and gasket may be formed in one piece, often with the gasket cast on the edges of the spacer.
Hydrodynamic resistance may refer to, according to some embodiments, a ratio between an applied pressure and a flow, for example, flow as expressed by a linear velocity of a solution passing through a stack.
Ion exchange capacity may refer to, according to some embodiments, an amount of fixed charges per unit dry weight of a polymer or of a membrane.
Ion exchange membranes may refer to, according to some embodiments, membranes designed for transfer of ions. They carry fixed charges, for example, they may contain polymers which carry ionic groups. Electro neutrality is maintained by mobile counter-ions of opposite sign to that of the polymer, cations in cation exchange membranes and anions in anion exchange membranes. Co-ions are ions of the same sign as the polymer
Ionomers may refer to, according to some embodiments, polymers containing both hydrophilic charged groups and hydrophobic groups. Ionomers are generally soluble in organic solvents and insoluble in water.
Membrane package may refer to, according to some embodiments, a plurality of cell pairs in which all elements are suitably connected together.
Module (membrane module) may generally refer to, according to some embodiments, connected groups of elements such as membranes. Modules may include a membrane package, fastened in a frame, and may further include a framed cell on one end in some embodiments. A plurality of modules not carrying a framed cell may be separated by a gasket.
Permselectivity of a membrane may refer to, according to some embodiments, discrimination between cations and anions. In a highly perm selective membrane, electric current is carried mostly by ions of one sign and by only a small amount of ions of an opposite sign.
Potting may refer to, according to some embodiments, a procedure comprising binding membrane elements such as flat sheets or capillaries into one body by setting glue, so that the interior of the capillary or some predetermined spaces between membranes remain accessible and others are blocked.
Process stream may refer to, according to some embodiments, a solution flowing through compartments alternate to the feed stream, the compartments referred to as process compartments.
Reversed Electrodialysis (RED) may refer to, according to some embodiments, a process in which the free energy of a concentration gradient is converted into electric energy by allowing diffusion of salt from a solution of high concenetration to low concentration through an electrodialysis stack
Seal (sealing) may refer to, according to some embodiments, a tight (generally) permanent adherence between limited areas of two membranes or a spacer, and one or two membranes, and the process creating this adherence. Sealing may be achieved by glue or thermal sealing or any other suitable method.
Sealing or gluing may also refer to any mode of permanent connection between elements such as, for example, membranes or spacers, or gasket and frame.
Shape-stable membranes may refer to, according to some embodiments, membranes which have essentially equal length dimensions in dry and wet states.
Sleeves may refer to, according to some embodiments, two membranes sealed along at least two parallel edges, possibly sealed with a spacer between them. The membranes may be sealed together by strips along the edges. Optionally, a membrane may be part of two adjacent sleeves.

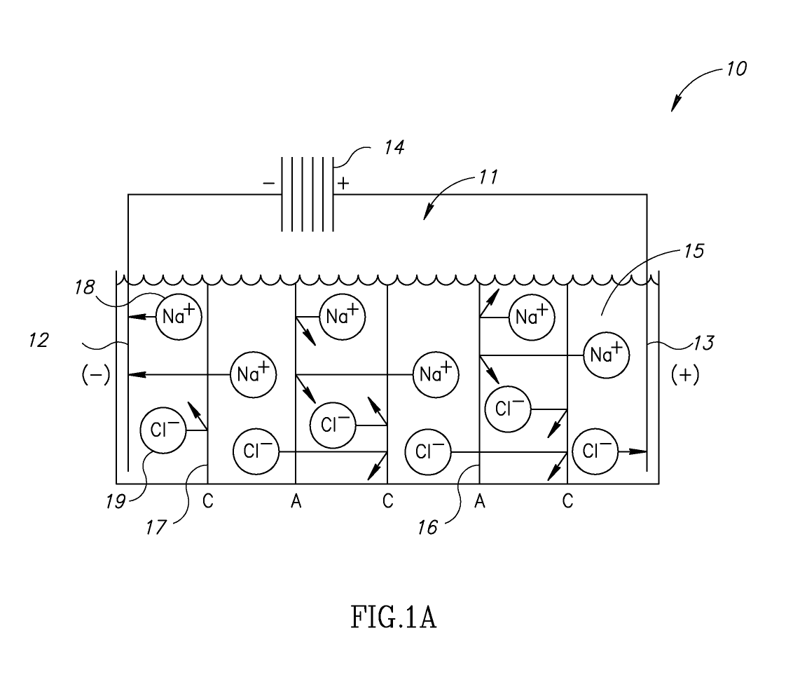

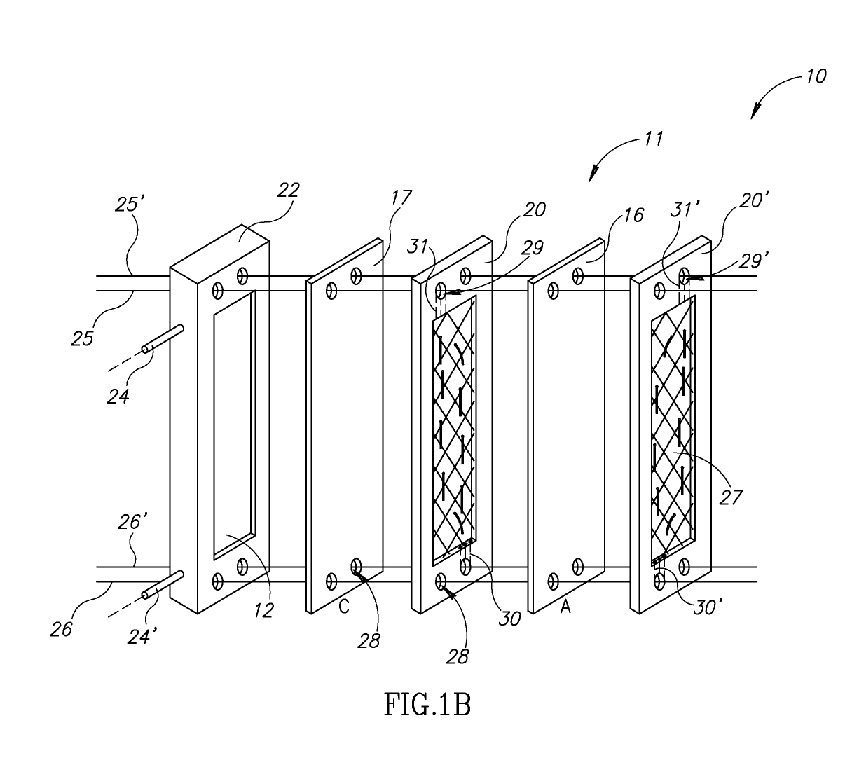

Reference is made to FIG. 1 A, which schematically illustrates an exemplary ED device 10 as known in the art. ED device 10 typically comprises an ED stack 11 and a direct current (DC) voltage source 14 connected to electrodes at opposite ends of the ED stack, the electrodes comprising a cathode (negatively charged terminal) 12 and an anode (positively charged terminal) 13. ED stack 11 generally comprises alternately arranged one or more cation exchange membranes 17, and one or more and anion exchange membranes 16, the ED stack adapted to permit a fluid 15, such as, for example, a salt-containing fluid (brackish water), to flow between the membranes in a direction parallel to a surface of the membranes. Cation exchange membrane 17 is adapted to allow positive ions 18 in fluid 15, such as, for example, Sodium (Na+), to migrate from a first side of the membrane to an opposite second side of the membrane, in a direction of cathode 12, while blocking passage of negative ions 19 in the fluid, such as for example, Chloride (Cl−) 19. Anion exchange membrane 16 is adapted to allow negative ions 19 in fluid 15 to migrate from a first side of the membrane to an opposite second side of the membrane, in a direction of anode 13, while blocking passage of positive ions 18.

Reference is made to FIG. 1B, which schematically illustrates an exploded isometric view of part of an ED device 10 and of a cell pair included in ED stack 11, shown in FIG. 1A, as known in the art. ED device 10 may comprise a plurality of cell pairs which may range in numbers for example, from 2-300 cell pairs, and sometimes more. The cell pair includes a parallel arrangement of cation exchange membrane 17, anion exchange membrane 16, a feed spacer 20 between the two ion exchange membranes, and a process spacer 20′ located adjacent to the anion exchange membrane. Feed spacer 20 and process spacer 20′ are adapted to conduct fluid flow in a direction parallel to, and between, cation exchange membrane 17 and anion exchange membrane 16. Feed spacer 20 and process spacer 20′ comprise a plurality of interfering elements 27 adapted to introduce turbulence in the fluid flow while minimizing pressure drop. Optionally, feed spacer 20 may be the process spacer and process spacer 20′ may be the feed spacer. Located at each end of ED stack 11 are the electrodes, for example cathode 12 as shown in the figure at one end of the ED stack, the two electrodes adapted to apply an electric potential required to drive the ion separation. Each electrode is built into an electrode cell which also serves as end-plates for the ED stack; for example, cathode 12 is built into end plate (electrode cell) 22. The electrode cell, for example electrode cell 22, each comprise an entry port 24 and an exit port 24′ for adding and removing solutions and/or chemicals typically required to control process conditions at the electrodes, including cleaning of the electrodes. For example, hydrochloric acid may be added to cathode 12 to prevent scaling on the electrodes or in the electrode compartments.

In an exemplary desalination process by ED, a feed stream 26 and a process stream 26′ may flow through conduits 28 into compartments formed between membranes 16 and 17. Feed stream 26 enters into feed spacer 20 and process stream 26′ into process spacer 20′ through an entry port 30 and 30′ comprised in each spacer, respectively. Application of the electric potential to the electrodes causes a direct current to flow through ED stack 11 from one electrode to another, separating the ions in feed stream 26 and process stream 26′, creating a feed stream 25 and a process stream 25′ in alternate compartments. For example, feed stream 25 may be created in a feed compartment comprising feed spacer 20, while process stream 25′ may be created in a process compartment comprising process spacer 20′. Process stream 25′ flows out of process spacer 20′ through exit port 31′, and flows through conduits 29′ out of the process compartments and out of ED stack 11. Feed stream 25 flows out of feed spacer 20 through exit port 31, and flows through conduits 29 out of the feed compartments and out of ED stack 11.

The compartments are generally maintained relatively thin, usually in a range of 0.5-1.0 mm, in an attempt to maintain a total electrical resistance in ED stack 11 relatively low. A high electrical resistance implies a greater need for electrical power in order to obtain the necessary direct current required for ion separation.

ED device 10 may be adapted to be used for Electrodialysis Reversal (EDR) processes. In an EDR configuration, the polarity of electrodes 12 and 13 will be reversed, for example, three to four times per hour. Reversing the polarity of electrodes 12 and 13 reduces scaling and fouling in ion exchange membranes 16 and 17 by alternating process into feed and feed into process.

For example, the feed stream may be seawater and the process stream may be river water.

ED device 10 may be used in different applications where a composition of two separate streams flowing through ED stack 11 depends on the nature of the process. For example, feed stream 26 and process stream 26′ may be a mixed fluid comprising a product of a relative value such as amino acids or various pharmaceutical products, and salts which are to be removed. Feed stream 25 may comprise a fluid with the relatively valuable product. ED device 10 may also be adapted to be used for acidification of a fluid. For example, all anion exchange membranes 16 may be replaced by cation exchange membranes 17, such that all ion exchange membranes in ED stack 11 are cation exchange membranes 17. In this case, feed stream 26 and process stream 26′ are a fluid which should be acidified, and feed stream 25 is an acid fluid. ED device 10 may be further adapted to perform a process known as Donnan dialysis, or diffusion dialysis, which may be carried out in ED stack 11 comprising only cation exchange membranes 17, or optionally only anion exchange membranes 16, allowing ion exchange without the passage of electric current.

Generally, ED device 10, in the configuration shown, may not be used with very dilute solutions as electric resistance is substantially high due to bulk resistance and strong concentration polarization. This may be overcome by filling the feed compartments with an ion exchange resin, usually mixed bed. This process, used for preparing substantially pure water, is a version of electrodialysis generally referred to as electro-deionization (EDI) or continuous electro-deionization (CEDI). For some deionization stacks, a cation exchange membrane and an anion exchange membrane are sealed to a spacer, and a resulting feed cell is filled with ion exchange resin. More about such stacks for deionization may be found in Giuffrida et al., Electro-deionization Apparatus and Method, U.S. Pat. No. 4,925,541, 1990; Liang et al., Modules for Electro-deionization Apparatus, U.S. Pat. No. 5,292,422; both of which are hereby incorporated by reference in their entirety.

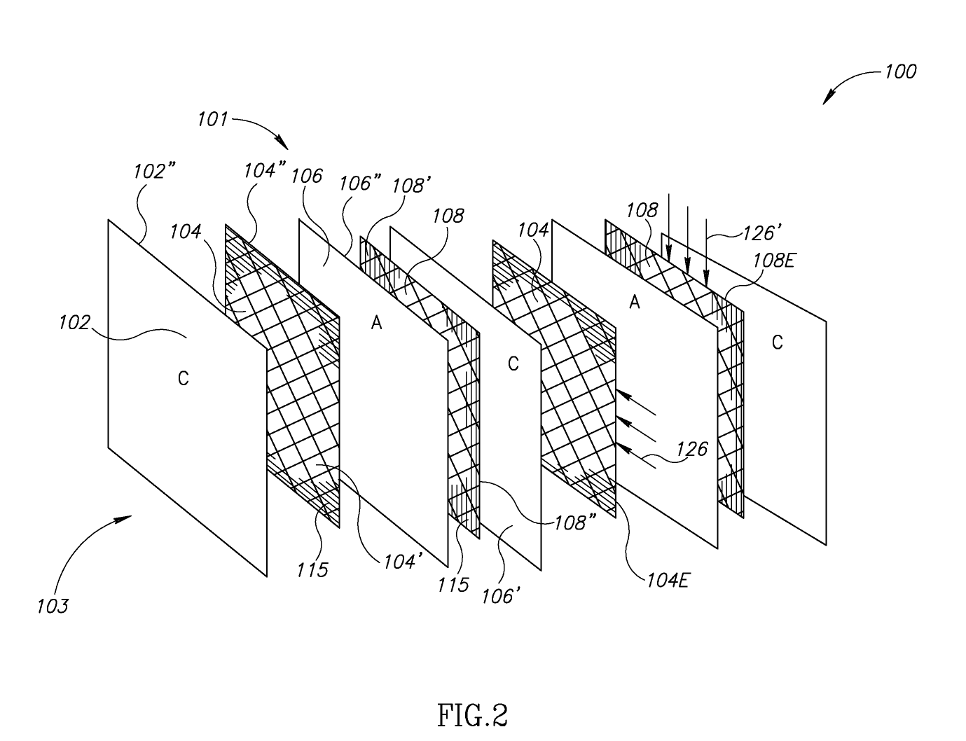

Reference is made to FIG. 2 which schematically illustrates an exploded isometric view of a plurality of cell pairs 101, comprised in a membrane package 103 comprised in an apparatus 100, the apparatus adapted to be used to dilute and/or concentrate a solution in a desalination process, in accordance with an embodiment of the invention. Optionally, apparatus 100 may be adapted for use in processes such as ED, EDR, Donnan Dialysis, EDI, CEDI, and the like. Apparatus 100 may form an acid and/or a basic solution in a neutralization process; diffuse a concentrated solution and a more dilute water source in an energy conversion process; selectively move ions in a solution, or optionally de-ionize the solution, as may be required by a desired process; and/or any combination thereof. In some embodiments of the invention, apparatus 100 may be used for Reversed Electrodialysis (RED), wherein passage of salt from a concentrate to a dilute creates a current due to the diffusion potential (while in regular ED a potential is applied which is high enough to drive salt from dilute into concentrated solution).

Cell pair 101 may comprise two ion exchange membranes, such as a cation exchange membrane 102 and an anion exchange membrane 106; a first spacer 104; and a second spacer 108, the same or substantially similar to spacer 104. Optionally, cell pair 101 may comprise a second cation exchange membrane 102 instead of anion exchange membrane 106, for example, for apparatus 100 use for acidification processes and/or Donnan dialysis. Optionally, cell pair 101 may comprise a second anion exchange membrane 106 instead of cation exchange membrane 102, for apparatus 100 use for Donnan dialysis.

In accordance with an embodiment of the invention, the ion-exchange membranes are sealed to each other in membrane package 103 by connecting strips 115 with the strips vertically alternating. Cell pair 101 may be formed by attaching a first side 102″ of cation exchange membrane 102 to a first side 104′ of first spacer 104 along two opposing, parallel edges, such as a top edge and an opposite bottom edge; attaching a first side 106′ of anion exchange membrane 106 to a second side 104″ of first spacer 104 (along the same edges as spacer 104 is attached to membrane 102); and attaching a first side 108′ on second spacer 108 to a second side 106″ on anion membrane 106 along two opposing, parallel edges perpendicular to sealed edges of first spacer 104. Methods used for attaching spacer 104, spacer 108, cation exchange membrane 102, and anion exchange membrane 106, may comprise the use of connecting element 115. The connecting element, such as connecting element 115, may include, for example, a strip, such as a solid strip, of any suitable material. The connecting element, such as connecting element 115, may be adapted to connect a membrane (such as cation exchange membrane 102 and/or anion exchange membrane 106) to a spacer (such as spacer 104 and/or spacer 108) without deforming the spacer. The connecting element may be solution-resistant. The connecting element may include, for example, adhesive strips of thickness ranging between 0.5-10 mm (such as 2-4 mm). The connecting element may be a part of the spacer (such as an integral part of a spacer or a part assembled to the spacer) or an element separate from the spacer. The connecting element may include, for example, thermal sealer; glue, epoxies, and the like and/or cross linking of polymers comprised in a sealing solution and the ion exchange membranes. Sealing of the edges may comprise use of the same methods used for attaching spacers 104 and 108 to membranes 102 and 106, the connecting element optionally extends to include corners of the spacers and the membranes. Optionally, other methods known in the art may be used including solution-resistant potting, for example, silicon potting, resin potting, adhesive potting, and the like.

In accordance with an embodiment of the invention, a second cation exchange membrane 102, associated with second cell pair 101, may be attached to a second side 108″ of second spacer 108 (along the same edges as spacer 108 is attached to membrane 106). Membrane package 103 may be constructed in this manner to a predetermined thickness, with spacers 104 and 108 sealed along two opposite edges in alternating perpendicular directions to each other, creating perpendicular flow paths for a feed stream and a process stream, as shown by arrows 126 and 126′, respectively. Optionally, arrow 126 and arrow 126′ may represent a flow path for the process stream and the feed stream, respectively. Furthermore, the feed stream may flow into spacer 104 along a whole length of an unsealed edge 104E as indicated by multiple arrows, and may flow out along a whole length of the opposite unsealed edge. The process stream may flow into spacer 108 along a whole length of an unsealed edge 108E as indicated by multiple arrows, and may flow out along the whole length of an opposite unsealed edge, essentially perpendicularly to the flow of the feed stream.

Cation exchange membrane 102 and/or anion exchange membrane 106 may comprise shape-stable ion exchange membranes, the membranes adapted to maintain their linear dimensions in both dry and wet conditions to within 10% or less. Optionally, the dimensions are maintained to within a range of 5%-10% in both dry and wet conditions. Optionally, the dimensions are maintained to within a range of 2%-5% in both dry and wet conditions. Optionally, the dimensions are maintained to 2% or less in both dry and wet conditions. Change of dimensions may be minimized by limited swelling of the polymer material by cross linking and/or by a dimensionally stable membrane support. Cation exchange membrane 102 and/or anion exchange membrane 106 may comprise a thickness in a range from 25μ to 1 mm.

In some embodiments of the invention, the shape-stable membranes may be achieved by combining an ion exchange material known as ionomers, macromolecules in which a small but significant proportion of the constitutional units have ionizable or ionic groups, negative or positive or both, with an uncharged hydrophobic polymer. This combination provides for a membrane displaying substantially reduced swelling and relatively good conductance. Swelling may be decreased by increasing an inert polymer fraction in the combination. Optionally, swelling may be further suppressed by cross-linking or by mixing with uncharged polymer(s). Furthermore, due to mechanical properties of these polymers, membrane resistance may be kept sufficiently low by decreasing the thickness of the membrane (the thickness of the membrane may be, for example 20 micrometer-1 mm, such as 30-50 micrometer).

The uncharged polymer may be chosen from aromatic engineering plastics, as described below, such as polysulfone, polyethersulfone, polyphenylsulfone, polyetherether ketone. The ionomers may be produced by modification of these polymers. The uncharged polymer may be chosen from aromatic engineering plastics, as described below, such as polysulfone, polyethersulfone, polyphenylsulfone, polyetherether ketone. The ionomers may be produced by modification of these polymers or by synthesis from their monomer units, as may be found, for example, in US patent application 20060036064 by McGrath et al, which is incorporated herein by reference in its entirety.

In some embodiments of the invention, combinations of the ionomer and the uncharged polymer may be supported on a fabric or other reinforcement structure where there is relatively good adherence of the polymers to the support. Optionally, adherence of the polymers to the embedded support may be enhanced by choosing networks made from polymers, plastic, inorganic fibers, and the like, which are compatible with either the ionomer and/or the non charged hydrophobic polymer.

In some embodiments of the invention, shape-stable membranes may be formed from cross linking an ion exchange polyelectrolyte, (a macromolecule in which a substantial portion of the constitutional units have ionizable or ionic groups, or both) alone, or optionally within an inert matrix using methods known in the art. For example, copolymerization of vinyl aromatic polymers such as styrene (followed by sulfonation after polymerization) or styrene sulfonic acid with divinyl benzene, may yield cross linked cation ion exchange membranes; or a similar polymerization of halogenated (such as, for example chloro or bromo)—methylated styrene with di-vinyl-benzene and the subsequent quaternization reaction with tertiary amines and the bromo methyl groups to yield anion exchange membranes. This may be done in combination with the presence of a net or porous support which is embedded in the final polymer film. Optionally, the formulation may comprise a non-derivatized hydrophobic polymer, such as in commercial membranes, polyvinyl chloride, polyethylene-styrene-butadiene rubber and others. This mixture of inert polymers and the monomers may be coated on a fabric support, and polymerization is then carried out. In both cases of the support and hydrophobic polymer, the materials are chosen to have at least some interfacial compatibility with the cross linked ion exchange polymers for good mechanical strength and minimization of relatively large pores or pin holes. These approaches and other forms of stable membranes are described in H. Strathmann, “Ion Exchange Membrane Separation Processes”, Membrane Science and Technology Series, 9, Elsevie 2004, incorporated herein by reference in its entirety.

In some embodiments of the invention, the following polymers may be used as a hydrophobic polymer matrix, and/or as the starting polymer which is derivatized to form an ionomer by introducing ionic groups, to form the shape stable membranes: those made from condensation polymerization, such as polysulfone, polyether sulfone, polyphenylene sulfone, poly-ether-ketone, polyether-ether-ketone, polyether ketone-ether-ketone, polyphenylene sulfide, polyphenylene sulfone and variations of sulfide and sulfone in the same polymer and other variations of polyether ketones and poly-sulfone. Optionally, some of the categories of the ionic polymers may be derived from a polysulfone (PSU), polyphenylene oxide (PPO), polyphenylene sulfoxide (PPSO), polyphenylene sulfide (PPS), polyphenylene sulfide sulfone (PPS/SO.sub.2), poly-para-phenylene (PPP), poly-phenyl-quinoxaline (PPQ), poly-aryl-ketone (PK) and polyether-ketone (PEK) polymer, polyethersulfone (PES), polyether-ether-sulfone (PEES), polyarylethersulfone (PAS), polyphenylsulfone (PPSU) and poly-phenylene-sulfone (PPSO.sub.2) polymer; the polyimide (PI) polymer may comprise a polyetherimide (PEI) polymer; the polyether-ketone (PEK) polymer may comprise at least one of a polyether-ketone (PEK), polyether-ether-ketone (PEEK), polyether-ketone-ketone (PEKK), polyether-ether-ketone-ketone (PEEKK) and polyether-ketone-ether-ketone-ketone (PEKEKK) polymer; and the polyphenylene oxide (PPO) polymer may comprise a 2,6-diphenyl PPO or 2,6-dimethyl PPO polymer. Polyether-ketone polymers may include polyether-ketone (PEK), polyether-ether-ketone (PEEK), polyether-ketone-ketone (PEKK), polyether-ether-ketone-ketone (PEEKK) and polyether-ketone-ether-ketone-ketone (PEKEKK) polymers.

In some embodiments of the invention, homopolymers and/or copolymers may be used, for example, random copolymers, such as RTM, Victrex 720 P and RTM.Astrel. Optionally, polymers used may include polyaryl ethers, polyaryl thioethers, polysulfones, polyether ketones, polypyrroles, polythiophenes, polyazoles, phenylenes, polyphenylene-vinylenes, polyazulenes, polycarbazoles, polypyrenes, poly-indophenines and, polyaryl ethers. Examples of commercial sources for the homopolymers and/or copolymers may include Solvay, ICI, and BASF. Some examples of commercial homopolymers and/or copolymers include, UDEL™ polysulfone, RADEL™ A polyether sulfone, RADEL™ R polyphenylsulfone, and SOLEF™ fluoro-polymer produced by Solvay.

The anionic groups, on the cation exchange ionomers, may include sulfonic, carboxylic, and phosphonic. Optionally, sulfonated, carboxylated or phosphonated may be derived from polyphenylsulfone, polyether-ketone, polyetheretherketone polypropylene, polystyrene, polysulfone, polyethersulfone, polyetherethersulfone, polyphenylenesulfone, poly (bisbenzoxazol-1,4-phenylene), poly (bisbenzo (bis-thiazol)-1,4-phenylene), polyphenyleneoxide, polyphenylenesulfide, polyparaphenylene. Optionally, polytrifluorostyrene sulfonic acid, polyvinylphosphonic acid, and polystyrene sulfonic acid may be used. Some known limiting examples of sulfonated ionomers and their degree of substitution are: Sulfonated polyphenylsulfone 0.8 to 2.5 meq/gr., Sulfonated polysulfone 0.8, to 1.8, Sulfonated polyether sulfone 0.6, to 1.4, Sulfonated polyether ether ketone 1.0 to 3.0, Sulfonated polyether ketone 0.8, to 2.5. Sulfonated PVDF and sulfonated PVDF copolymers of 1.0 to 2.5 meq/gr. Optionally, counter ions of the ionomer or polyelectrolyte ionic groups may be chosen during fabrication of the membrane or during their use. Examples may include H+, Li+, K+, Na+, and NH₄+, and multivalent ions which may include, for example, Ca, Mg, and Zn ions.

Optionally, ionomers with cationic exchange groups may be chosen from quaternary ammonium, phosphonium and sulfonium. These may be made by methods known in the art, such as, for example (but not limited to), the derivation of the aromatic condensation polymer, such as polysulfone to form halomethylated polymers which may be converted to quaternary ammonium, phosphonium and sulfonium derivatives. Optionally, poly-4-vinylpyridine cross linked with dibromo or chloro alkanes with quaternization of the remaining pyridines with methyliodide, may be used.

In some embodiments of the invention, membranes may be formed by casting the polymer on a reinforcing material or substrate. Such substrate may be chosen from woven synthetic fabrics such as polypropylene cloth, polyacrylonitrile cloth, polyacrylonitrile-co-vinyl chloride cloth, polyvinyl chloride cloth, polyester cloth, and the like. Optionally, other substrates may include glass filter cloth, polyvinylidene chloride screen, glass paper, treated cellulose battery paper, polystyrene-coated glass fiber mat, polyvinyl chloride battery paper, and the like.

In some embodiments of the invention, cell pairs 101 and membrane package 103 may be adapted for EDI and/or CEDI. Cation exchange membrane 102 and anion exchange membrane 106 are attached to each other by connecting element 115 which may comprise, for example, adhesive strips of thickness ranging 2-4 mm. Wide spacers 104 and 108 may be inserted between cation exchange membrane 102 and anion exchange membrane 106; a width of the spacers is chosen to allow introduction of an ion exchange resin in a pressurized solution (without interfering with a stability of the resin bed). Optionally, spacers 104 and 108 are not used. Optionally, heterogeneous membranes comprising ion exchange resin embedded in an inert matrix may be used. The membranes may be sealed in dry or wet state using for the sealing a polymer of a lower glass temperature, T_{g}, compatible with the matrix polymer, such as for example “Engage” polymer for the seal of a matrix containing polyethylene. The strips comprise polymers compatible with the membranes. Membrane packages may be prepared by the methods described above, and a net may be glued to one edge of the package. Through the opposite edge, the sleeves are filled with ion exchange resin by pouring a suspension of the resin through the package until the sleeves are filled with resin. The membrane package is then sealed with a net.

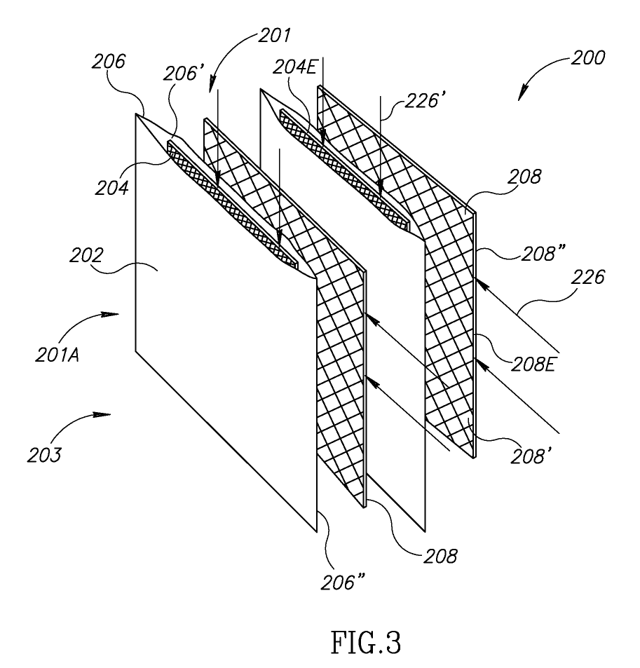

Reference is made to FIG. 3 which schematically illustrates an exploded isometric view of a plurality of exemplary cell pairs 201 comprised in a membrane package 203 comprised in an apparatus 200, the apparatus adapted for diluting and/or concentrating a solution in a desalination process, in accordance with an embodiment of the invention. Optionally, apparatus 200 may form an acid and/or a basic solution in a neutralization process; diffuse a concentrated solution and a more dilute water source in an energy conversion process; selectively move ions in a solution, or optionally de-ionize the solution, as may be required by a desired process; and/or any combination thereof. Apparatus 200 may be adapted for use in processes such as ED, EDR, Donnan Dialysis, EDI, CEDI, and the like.

Cell pair 201 may comprise two ion exchange membranes, such as a cation exchange membrane 202 and an anion exchange membrane 206; a first spacer 204; and a second spacer 208 which may be the same or substantially similar to spacer 204. Optionally, cell pair 201 may comprise a second cation exchange membrane 202 instead of anion exchange membrane 206, for example, for apparatus 200 use for acidification processes and/or Donnan dialysis. Optionally, cell pair 201 may comprise a second anion exchange membrane 206 instead of cation exchange membrane 202, for apparatus 200 use for Donnan dialysis. Cation exchange membrane 202, anion exchange membrane 206, a first spacer 204, and second spacer 208, may be the same or substantially similar to that shown in FIG. 1 at 102, 106, 104 and 108, respectively.

In accordance with an embodiment of the invention, cell pair 201 may be formed by attaching a first side 202″ of cation exchange membrane 202 to a first side 206′ of anion exchange membrane 206 along two opposing, parallel edges such as, for example, a side edge and an opposite side edge, forming a sleeve 201A, and first spacer 204 placed inside the sleeve; and attaching a first side 208′ on second spacer 208 to a second side 206″ on anion membrane 206 along two opposing, parallel edges perpendicular to the attached edges of sleeve 201A.

In accordance with an embodiment of the invention, a second sleeve 201A associated with a second cell pair 201, may be attached to a second side 208″ of second spacer 208, along the same edges attaching first side 208′ to sleeve 201A. A membrane package 203 may be constructed in this manner to a predetermined thickness, with spacers 204 and 208 sealed along two opposite edges in alternating perpendicular directions to each other, creating perpendicular flow paths for a feed stream and a process stream, as shown by arrows 226 and 226′, respectively. Optionally, arrow 226 and arrow 226′ may represent a flow path for the process stream and the feed stream, respectively. Furthermore, the feed stream may flow into spacer 204 along a whole length of an unsealed edge 204E as indicated by multiple arrows, and may flow out along a whole length of the opposite unsealed edge. The process stream may flow into spacer 208 along a whole length of an unsealed edge 208E as indicated by multiple arrows, and may flow out along the whole length of an opposite unsealed edge, essentially perpendicularly to the flow of the feed stream.

Methods used for attaching spacer 204, spacer 208, cation exchange membrane 202, and anion exchange membrane 206, may include, for example, thermal sealing; adhering by glue, epoxies, and the like; cross linking of polymers comprised in a sealing solution and the ion exchange membranes. Sealing of edges may comprise use of the same methods used for attaching spacers 204 and 208 to membranes 202 and 206, the sealing optionally extending to include corners of the spacers and the membranes. Optionally, other methods known in the art may be used including potting, for example, silicon potting, resin potting, adhesive potting, and the like. For example, a plurality of cell pairs may be clamped together to form membrane package 203. Two sides of membrane package 203, comprising openings of sleeve 201, may be partly dipped into the potting material such that the edges of spacer 208 are covered, as well as the sleeve openings. The potting material may then be removed from the openings of sleeve 201 by cutting a section of cation exchange membrane 202 and anion exchange membrane 206, while leaving the edges of spacer 208 covered.

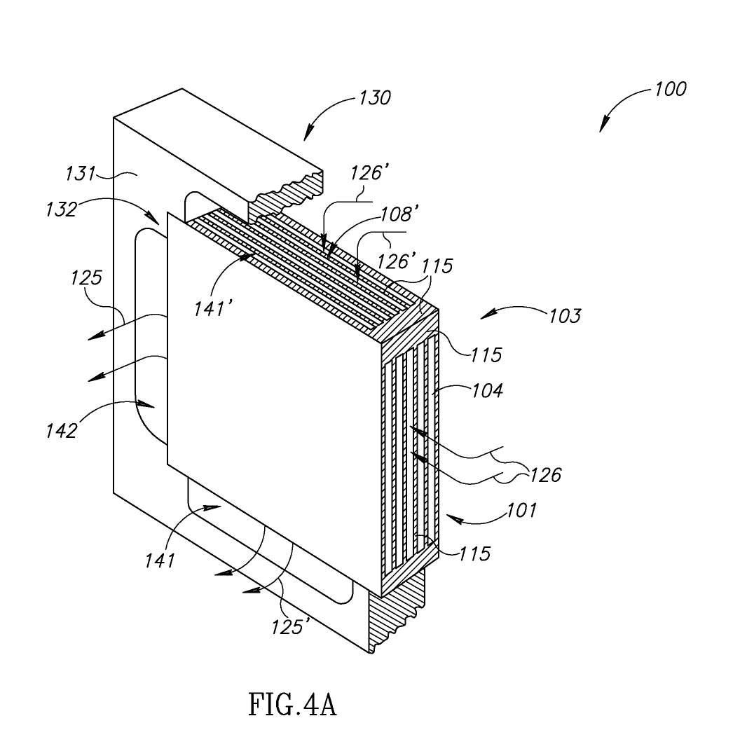

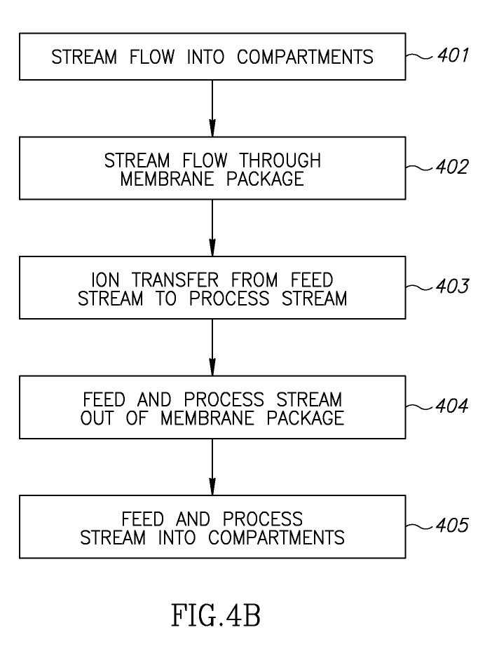

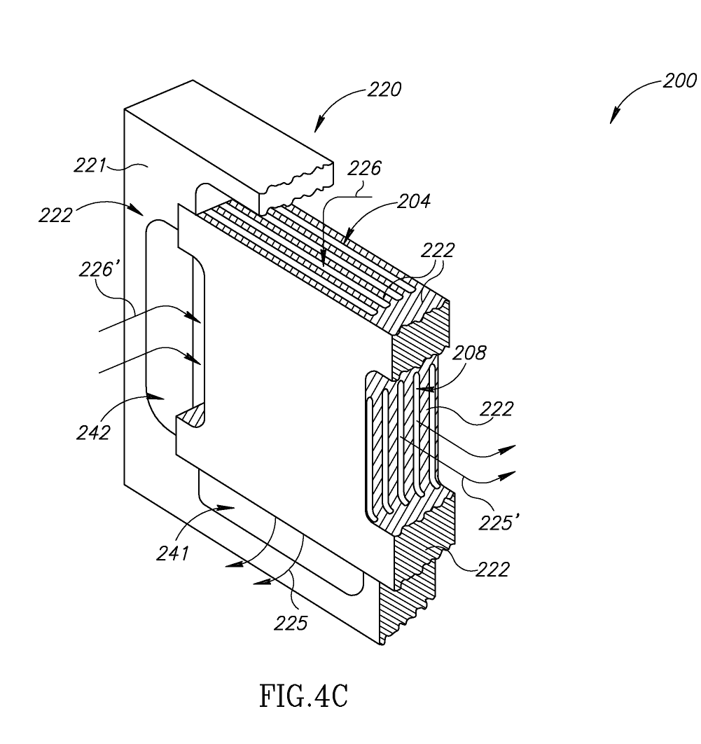

Reference is made to FIG. 4A, which schematically illustrates an isometric view of an exemplary module 130 comprised in apparatus 100, in accordance with an embodiment of the invention. Module 130 comprises a membrane package 103 as shown in FIG. 2, and a frame 131.

In accordance with an embodiment of the invention, module 130 is adapted to allow a substantially free flow of feed stream 126 and process stream 126′ through the module, the module comprising a relatively low hydrodynamic resistance to the flow of the two streams. Module 130 is further adapted to receive feed stream 126 and process stream 126′ and to direct their flow such that the streams may flow through membrane package 103 essentially perpendicular to one another, producing a feed stream 125 and a process stream 125′, respectively, according to a predetermined process (for example, ED, or optionally EDR, Donnan dialysis, acidification, neutralization, EDI, CEDI, and the like). Module 130 is additionally adapted to substantially prevent any mixing between any one, or any combination of, feed stream 126, process stream 126′, feed stream 125, and process stream 125′.

In accordance with an embodiment of the invention, membrane package 103 may comprise a plurality of cell pairs 101, for example 1-10 cell pairs, 10-20 cell pairs, 20-40 cell pairs, 40-80 cell pairs, 80-160 cells pairs, 160-320 cell pairs, and optionally more than 320 cell pairs. Membrane package 103 may comprise an even number of ion exchange membranes and may comprise at each end, cation exchange membrane 102, anion exchange membrane 106, or any combination thereof. Optionally, membrane package 103 may comprise a spacer 108 at one end, or optionally at both ends, of the package. Optionally, membrane package 103 may comprise an odd number of ion exchange membranes, and may comprise spacer 108 at either end of the package, or optionally at both ends of the package. The membranes (such as cation exchange membrane 102 and anion exchange membrane 106) are attached to spacer 108 by connecting element 115.

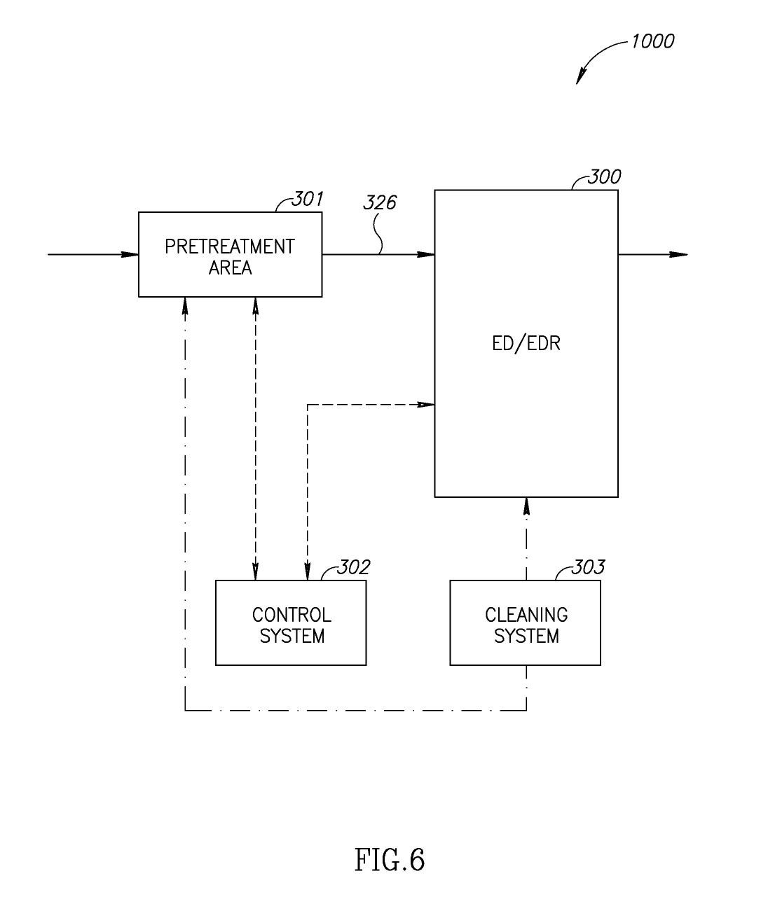

Frame 131 is adapted to support membrane package 103, and is further adapted to allow free flow of feed stream 126 and process stream 126′, and feed stream 125 and process stream 125′, inside module 130, while substantially preventing the streams from mixing with one another. Frame 131 may be shaped such that corners 132 in membrane package 103 may be affixed to predetermined areas in the frame, forming four compartments, such as, for example, compartments 141, 141′, 142, and 142′ (compartment 142′ is not shown in this figure—refer to FIG. 6). Optionally, more than four compartments may be formed. Compartments 141′ and 142′ are adapted to allow entry of process stream 126′ and feed stream 126 into the module, and compartments 141 and 142 are adapted to allow exit of process stream 125′ and feed stream 125 from the module. Optionally, other combinations of stream flow in module 130 are possible, as flow through membrane package 103 may be from any compartment in the module to a compartment on an opposite of the module; for example, feed stream 126 may enter through compartment 141′ and process stream through compartment 142′, feed stream exiting through compartment 141 and process stream exiting through compartment 142. Optionally, as an additional example for illustrative purposes, as other combinations are possible, feed stream 126 may enter through compartment 142 and process stream through compartment 141′, feed stream exiting through compartment 142′ and process stream exiting through compartment 141. Optionally, Frame 131 is additionally adapted to allow flow of feed stream 126, process stream 126′, feed stream 125, and process stream 125′, from one module 130 to another module 130, without mixing of the streams, when the modules are arranged in a stacked configuration, as will be described further on. Frame 131 may comprise a plastic material, a composite material, and/or any other material or combination of materials adapted to substantially resist contact with feed stream 126, process stream 126′, feed stream 125, and process stream 125′.

Reference is made to FIG. 4B which schematically illustrates a flow chart of an exemplary mode of operation of module 130, in accordance with an embodiment of the invention. The principles of the mode of operation herein described may be equally applicable to apparatus 100. For explanatory purposes, the exemplary mode of operation is based on an ED water desalination process.

[STEP 401] Feed stream 126 flows into compartment 142 and process stream 126′ flows into compartment 141′, both streams comprising salty water.

[STEP 402] Feed stream 126 flows from compartment 142 into membrane package 103 through substantially the whole length of the open edge of spacer 104. Feed stream 126 flow from compartment 142 into spacers 108 is substantially prevented as the edges of the spacer leading into the compartment are sealed with connecting element 115. Process stream 126′ flows from compartment 141′ into membrane package 103 through substantially the whole length of the open edge of spacer 108. Process stream 126′ flow from compartment 141′ into spacers 104 is substantially prevented, as the edges of the spacer leading into the compartment are sealed with connecting element 115. Feed stream 126 flow and process stream 126′ flow into membrane package 103 are essentially perpendicular to one another.

[STEP 403] Ions from feed stream 126 are transferred through cation exchange membrane 102 and anion exchange membrane 106 to process stream 126′ as the streams flow through spacers 104 and 108, respectively, while a direct current flows through membrane package 103 (a DC voltage source is connected across membrane package 103).

[STEP 404] Feed stream 126, in the form of feed stream 125 with composition changed by the transfer of ions throught the membranes, exits membrane package 103 through substantially a whole length of an open edge of spacer 104 opposite the open edge through which the feed stream entered. Process stream 126′, in the form of process stream 125′ with composition changed by the transfer of ions through the membranes, exits membrane package 103 through substantially a whole length of an open edge of spacer 108 opposite the open edge through which the feed stream entered. The flow of feed stream 125 and process stream 125′ are essentially perpendicular to one another as they exit membrane package 103.

[STEP 405] Feed stream 126 flows into compartment 142 and is conducted out of module 130. Process stream 126′ flows into compartment 141 and is conducted out of module 130, without mixing with feed stream 126.

The exemplary mode of operation described is not intended to be limiting in any form or manner. It may be evident to a person skilled in the art that other modes of operation are possible, which may include variations in the steps performed including the sequence in which they are performed.

Reference is made to FIG. 4C, which schematically illustrates an isometric view of an exemplary module 220 comprised in apparatus 200, in accordance with another embodiment of the invention. Module 220 comprises a membrane package 203 as shown in FIG. 3, and a frame 221.

In accordance with an embodiment of the invention, module 220 is adapted to allow a substantially free flow of feed stream 226 and process stream 226′ through the module, the module comprising a relatively low hydrodynamic resistance to the flow of the two streams. Module 220 is further adapted to receive feed stream 226 and process stream 226′ and to direct their flow such that the streams may flow through membrane package 203 essentially perpendicular to one another, producing a feed stream 225 and a process stream 225′, respectively, according to a predetermined process (for example, ED, or optionally EDR, Donnan dialysis, acidification, neutralization, EDI, CEDI, and the like). Module 220 is additionally adapted to substantially prevent any mixing between any one, or any combination of, feed stream 226, process stream 226′, feed stream 225, and process stream 225′. Module 220 is the same or substantially similar to module 130 in fit, form, and function, and may be optionally interchangeable with module 130 in apparatus 100. Feed stream 226, process stream 226′, feed stream 225, and process stream 225′ may be the same or substantially similar to that shown in FIG. 4A at 126, 126′, 125, and 125′.

In accordance with an embodiment of the invention, membrane package 203 is formed by a potting process, for example, such as the process previously described, potting material 222 providing structural rigidity to the membrane package and sealing openings to spacers 204 and 208. Membrane package 203 may comprise a plurality of cell pairs 201 which are attached to one another by potting material 222, for example 1-10 cell pairs, 10-20 cell pairs, 20-40 cell pairs, 40-80 cell pairs, 80-160 cells pairs, 160-320 cell pairs, and optionally more than 320 cell pairs. Membrane package 203 may comprise an even number of sleeves 201A, or optionally an odd number of sleeves, and may comprise at each end, cation exchange membrane 202, anion exchange membrane 206, or any combination thereof. Optionally, membrane package 203 may comprise a spacer 208 at one end, or optionally at both ends, of the membrane package.

Frame 221 is adapted to support membrane package 203, and is further adapted to allow free flow of feed stream 226 and process stream 226′, and feed stream 225 and process stream 225′, inside module 220, while substantially preventing the streams from mixing with one another. Frame 221 may be shaped such that potted corners 222 in membrane package 203 may be affixed to predetermined areas in the frame, forming four compartments, such as for example compartments 241, 241′, 242, and 242′ (compartments 241′ and 242′ are not shown in this figure and lie opposite compartments 241 and 242 in module 220, respectively, and are essentially a mirror-image of compartments 241 and 242). Optionally, more than four compartments may be formed. Compartments 241′ and 242 are adapted to allow entry of feed stream 226 and process stream 226′ into the module, and compartments 241 and 242′ are adapted to allow exit of feed stream 225 and process stream 225′ from the module. Optionally, other combinations of stream flow in module 220 are possible, as flow through membrane package 203 may be from any compartment in the module to a compartment on an opposite of the membrane package; similar to stream flow in module 130. Optionally, Frame 131 is additionally adapted to allow flow of feed stream 226, process stream 226′, feed stream 225, and process stream 225′, from one module 220 to another module 220, without mixing of the streams, when the modules are arranged in a stacked configuration, similar to module 130. Frame 231 may comprise a plastic material, a composite material, and/or any other material or combination of materials adapted to substantially resist contact with feed stream 226, process stream 226′, feed stream 225, and process stream 225′.

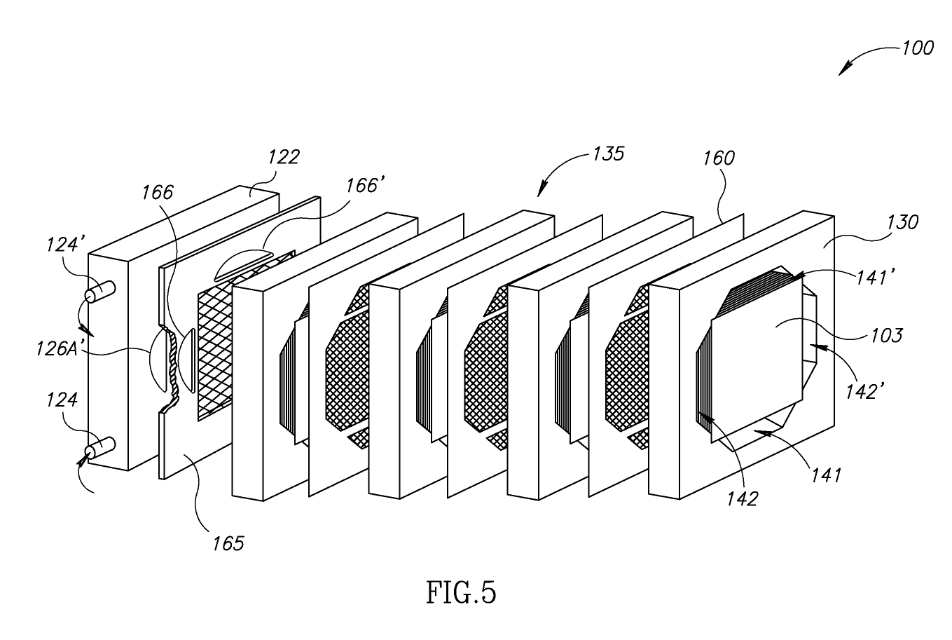

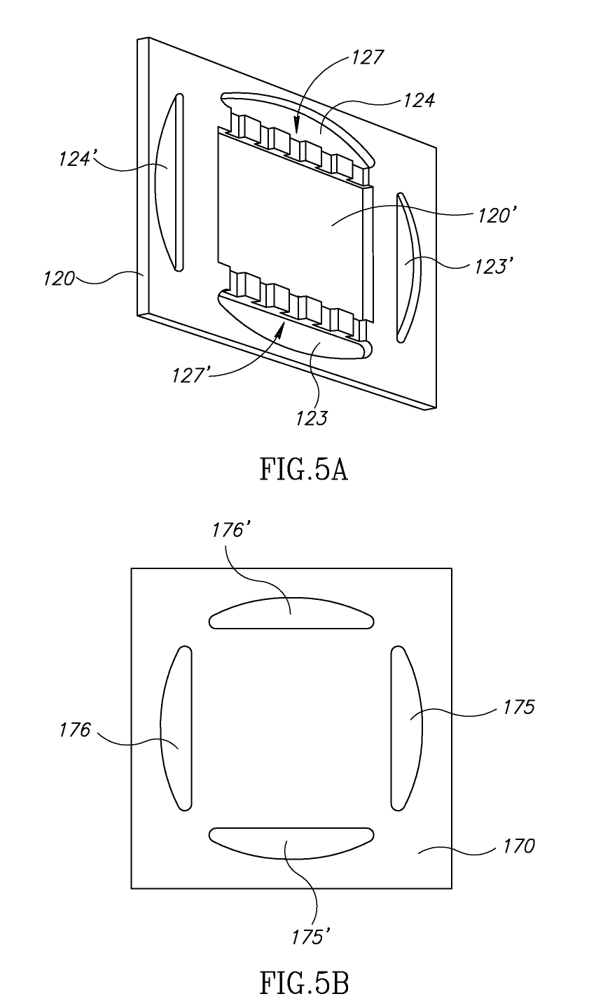

Reference is made to FIG. 5, which schematically illustrates an exploded isometric view of a part of apparatus 100, configured with a ED stack 135 comprising a plurality of modules 130 shown in FIG. 4A, in accordance with an embodiment of the invention. Optionally, ED stack 135 may comprise a plurality of modules 220 shown in FIG. 4C. Optionally, ED stack 135 may comprise one module 130 or one module 220. Optionally, ED stack 135 may comprise one or more modules 130 and one or more modules 220. ED stack 135 may be configured into a vertical stack of modules 130 by placing one module on top of another module. Optionally, modular stack 135 may be configured into a horizontal stack of modules 130 by placing one module next to another module.

Apparatus 100 additionally comprises two electrodes (not shown), a cathode and an anode, each electrode built into an end plate 122 at each end of ED stack 135. For example, end plate 122 shown may comprise the cathode. The electrodes are connected to a DC voltage source (not shown) and are adapted to produce a direct current, which flows from one electrode to the other through ED stack 135 when feed stream 126 and process stream 126′ flow through modules 130, including through membrane package 103. Optionally, the electrodes are adapted to change polarity (cathode becomes the anode and the anode becomes the cathode) responsive to a reversing of polarity in the DC voltage source, a direction of direct current flow in ED stack 135 according to the polarity of the electrodes. In accordance with an embodiment of the invention, end plate 122 comprises a first opening (not shown) and a second, opening 126A′ (substantially positioned at a right angle with first opening) adapted to allow feed stream 126 and process stream 126′ entering ED stack 135 to flow to modules 130 through compartments 141′ and 142 in the modules, respectively. End plate 123 further comprises a third opening (not shown, positioned substantially opposite to first opening) and a fourth opening (not shown, positioned substantially opposite to second opening) adapted to allow feed stream 125 and process stream 125′, both with composition changed by the transfer of ions inside modules 130, to return to end plate 122 through compartments 141 and 142′ in the modules, respectively, and thereon out of ED stack 135. A gasket 165 may be placed at the connection of end plate 122 with modules 130, and comprises a first opening 166, a second opening 166′, a third opening (not shown, positioned substantially opposite to first opening 166) and a fourth opening (not shown, positioned substantially opposite to second opening 166′), adapted to allow the flow of the feed and process streams in and out of end plate 122 without leakage or mixing of the streams together. End plate 122 additionally comprises an entry port 124 and an exit port 124′ for adding and removing solutions and/or chemicals typically required for controlling process conditions at the electrodes, including cleaning of the electrodes. For example, hydrochloric acid may be added to electrode cell 122 to prevent scaling in the electrode.

To substantially prevent leakage and mixing between feed stream 126, process stream 126′, feed stream 125 and/or process stream 125′, while flowing through the respective compartments from one module 130 to another module 130, a gasket 160 may be placed between the modules. Gasket 160 is adapted to allow the passage of the streams from one compartment in module 130 to a similar compartment in the adjacent module 130, without leaking or mixing between the streams comprised in other compartments in the same module, or in adjacent modules. For example, gasket 160 may permit feed stream 126 to pass from compartment 141′ in module 130 to same compartment 141′ in the adjacent module, while permitting process stream 126′ to pass from compartment 142 in module 130 to compartment 142 in the adjacent module, without leaking or mixing between them. Optionally, gasket 160 may be affixed to module 130, for example, by attaching the gasket to one side of frame 131 (the gasket is not necessary on both ends of module 130). Optionally, gasket 160 may be built into a frame, the frame adapted to be placed between modules 130.

Reference is made to FIGS. 5A and 5B which schematically illustrate an exemplary plate 123 and elastic layer 170 for use in a multi-module stack, in accordance with an embodiment of the invention. As an alternative to gaskets 160 and/or 165 described above, plate 123 may comprise a cell pair (not shown) which may form one side of each module in a multi-module stack. Each end of a membrane package (not shown) may include a spacer, and connecting strips, without a membrane. The connecting strips at both ends may be oriented in the same direction. Optionally, the connecting strips at one end may be oriented in a different direction than that at the other end, for example, perpendicularly to one another. When the membrane package is inserted into a frame, both strips are level with a surface of the frame. If the ED stack comprises only one module the frame and strips will be pushed against the end plates, which are coated with thin elastic layer 170.

For multi-module stacks, thin plate 123 is added onto one side of each module. Plate matches the frame, with openings 123, 123′, 124 and 124′, for both feed and process streams. Plate 123 includes the cell (not shown) consisting of two membranes sealed to the edges of a rectangular opening 120′ in the plate, with a spacer between the membranes. Flow through the cell is enabled by entrance/exit ports 127 and 127′, along the edges of opening 120′ perpendicular to the orientation of the connecting strips. A width of plate 123, of the cell and size and number of entrance/exit ports 127 and 127′, are adjusted so that the hydrodynamic resistance of the cell is equal to or slightly larger than that of the cells in the membrane package. Plate 123 is adhered to the frame on one side of the membrane package, generally by attaching to the strips on the spacer. A second side of thin plate 123 is covered with thin elastic layer 170.

Reference is made to FIG. 6 which schematically illustrates a system 1000 comprising an apparatus 300 adapted to perform ED, in accordance with an embodiment of the invention. Apparatus 300 may be the same or substantially similar to apparatus 100 shown in FIG. 5. Optionally, apparatus 300 may be adapted to perform EDR. Optionally, apparatus 300 may be adapted to perform acidification and/or neutralization. Optionally, apparatus 300 may be adapted to perform Donnan apparatus. Optionally, apparatus 300 may be adapted to perform EDI or CEDI. Optionally, apparatus 300 may be adapted to selectively move ions in a solution, or optionally de-ionize the solution. Optionally, system 1000 may comprise any one or any combination of, the above mentioned apparatus 300. Optionally, system 1000 may comprise a plurality of the above mentioned apparatus 300; the apparatus may be serially connected together. Optionally, the plurality of apparatus 300 may be connected in a parallel configuration. Optionally, the plurality of apparatus 300 may be connected in any combination of parallel—serial configuration.

System 1000 additionally comprises a pretreatment system 301, a control system 302, and an optional cleaning system 303. Pretreatment system 301 may be adapted to precondition a feed stream 326 (which may also comprise a process stream), and may include filtering large solids, anti-bacterial treatment, anti-fouling treatment, and/or anti-scaling treatment. Cleaning system 303 may be adapted to clean module stacks, electrodes, and other components comprised in apparatus 300. Optionally, cleaning system 303 may be adapted to clean pretreatment system 301. Control system 302 is adapted to control operation of apparatus 300, which may include monitoring of processes, and may be further adapted to control pretreatment system 302. Optionally, control system 302 may be adapted to control cleaning system 303.

In the description and claims of embodiments of the present invention, each of the words, “comprise” “include” and “have”, and forms thereof, are not necessarily limited to members in a list with which the words may be associated.

The invention has been described using various detailed descriptions of embodiments thereof that are provided by way of example and are not intended to limit the scope of the invention. The described embodiments may comprise different features, not all of which are required in all embodiments of the invention. Some embodiments of the invention utilize only some of the features or possible combinations of the features. Variations of embodiments of the invention that are described and embodiments of the invention comprising different combinations of features noted in the described embodiments will occur to persons with skill in the art.

1.-23. (canceled)

24. A membrane package comprising:
at least a first cell pair and a second cell pair, with the first cell pair comprising first and second membranes sealed together along two parallel edges of the first membrane, and with the second cell pair comprising third and forth membranes sealed together along two parallel edges of the third membrane,
wherein the two parallel edges of the first membrane are parallel to the two parallel edges of the third membrane,
wherein the second and third membranes are sealed together along two parallel edges of the second membrane, wherein the two parallel edges of the second membrane are perpendicular to the two parallel edges of the first membrane, and
wherein the membrane package is adapted to allow essentially free flow of a feed stream on one side of the second membrane and free flow of a process stream on a second side of the aid second membrane with the feed stream flow essentially perpendicular to the process stream flow.

25. The membrane package of claim 24, adapted to be affixed to a frame such that corners of the membrane package are affixed to predetermined areas in the frame, forming a module having separate spaces adapted to facilitate separate flows of the feed stream and the process stream through the membrane package.

26. The membrane package of claim 24, comprising a plurality of cell pairs.

27. The membrane package of claim 24, wherein the first cell pair further comprises a first spacer disposed between the first membrane and the second membrane, and a second spacer disposed between the second membrane and the third membrane, and wherein the second cell pair further comprises a third spacer disposed between the third membrane and the forth membrane, and a fourth spacer disposed between the forth membrane and a fifth membrane, wherein the cell pair is adapted to allow free flow of the feed stream through the first spacer and free flow of the process stream through the second spacer.

28. The membrane package of claim 27, wherein the first membrane, the second membrane are sealed together with the first spacer, the second membrane and the third membrane are sealed together with the second spacer, the third membrane and the forth membrane are sealed together with the third spacer and the forth membrane and the fifth membrane are sealed together with the fourth spacer along two parallel edges of the forth membrane, wherein the two parallel edges of the fourth membrane are perpendicular to the two parallel edges of the third membrane.

29. The membrane package of claim 24, wherein at least one connection between any two membranes comprises a connecting element.

30. The membrane package of claim 29, wherein the connecting element comprises a strip.

31. The membrane package of claim 24, wherein the first membrane and the second membrane constitute a first sleeve and wherein the third membrane and the forth membrane constitute a second sleeve, and wherein the second membrane and the third membrane are sealed together by a potting compound.

32. The membrane package of claim 24, wherein the feed stream and the process stream are essentially not mixing with one another.

33. The membrane package of claim 24, adapted to allow the feed stream flow between the first membrane and the second membrane and the process stream flow between the second membrane and the third membrane.

34. The membrane package of claim 24, adapted to allow feed stream flow through the first spacer and the third spacer and a process stream flow through the second spacer.

35. The membrane package of claim 24, wherein the first membrane, the second membrane, the third membrane, the forth membrane or any combination thereof are ion exchange membranes.

36. The membrane package of claim 35, wherein the first membrane, the third membrane or both are anion exchange membranes.

37. The membrane package of claim 35, wherein the second membrane, the forth membrane or both are cation exchange membranes.

38. The membrane package of claim 35, wherein the first membrane, the second membrane, the third membrane and the forth membrane are cation exchange membranes.

39. The membrane package of claim 24, adapted to be used in electrodialysis ED, electrodialysis reverse ED (EDR), Donnan Dialysis, Electro-deionization (EDI), Continuous Electro-deionization (CEDI), and/or Reversed Electrodialysis (RED), or any combination thereof.

40. A membrane module comprising:
a membrane package comprising a plurality of at least a first cell pair and a second cell pair, with the first cell pair comprising first and second membranes sealed together along two parallel edges of the first membrane, and with the second cell pair comprising third and forth membranes sealed together along two parallel edges of the third membrane,
wherein the two parallel edges of the first membrane are parallel to the two parallel edges of the third membrane,
wherein the second membrane and the third membrane are sealed together along two parallel edges of the second membrane, wherein the two parallel edges of the second membrane are perpendicular to the two parallel edges of the first membrane,
wherein the membrane package is adapted to allow essentially free flow of a feed stream on one side of the second membrane and free flow of a process stream on a second side of the second membrane with the feed stream flow essentially perpendicular to the process stream flow; and
a frame adapted to support the membrane package, such that corners of the membrane package are affixed to predetermined areas in the frame, forming a module having separate spaces adapted to facilitate separate flows of the feed stream and the process stream through the membrane package.

41. The membrane module of claim 40, wherein the first cell pair further comprises a first spacer disposed between the first membrane and the second membrane, and a second spacer disposed between the second membrane and the third membrane, and wherein the second cell pair further comprises a third spacer disposed between the third membrane and the forth membrane, and a fourth spacer disposed between the forth membrane and a fifth membrane, wherein the cell pair is adapted to allow free flow of the feed stream through the first spacer and free flow of the process stream through the second spacer.

42. An electrodialysis stack comprising at least one module according to claim 40 and electrode cells.

43. The electrodialysis stack of claim 42, comprising at least two modules wherein the modules are separated by a gasket or plate, wherein the plate comprises a cell pair comprising two membranes and a spacer separating them.
